(19) United States
(12) Patent Application Publication
(10) Pub. No.: US 2005/0099807 A1
(43) Pub. Date: May 12, 2005

(54) Pipe-type lamp with printed circuit

(76) Inventor: Wun-Feng Pan, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/704,916

(22) Filed: Nov. 12, 2003

(51) Int. Cl. F21V 23/02

(52) U.S. Cl. 362/221; 362/222; 362/240

(57) ABSTRACT

The invention relates to a pipe-type lamp with printed circuit, which includes an inner tube and an outer tube, wherein the inner tube is provided with printed circuit connecting with lighting bulbs. Hence, the pipe-type lamp can be manufactured and used more conveniently. And the electrical connection between the bulb and the circuit will be more secured that allows the lamp to be bent as desired.

### BACKGROUND OF THE INVENTION

A conventional pipe-type lamp usually includes an inner tube (1) and an outer tube (2). The inner tube (1) has been provided with several miniature bulbs (3) therein, while each miniature bulb (3) is connected with another one by the metal electrical wire (31), as shown in FIG. 1 and 2. It is possible to use the LED bulb (4) to replace the miniature bulb (3), as in FIG. 3, to lower used temperature of the lamp. The prior structure has the bulb being connected together by the metal wire (31). It is very difficult to manufacture and to connect the bulb in secure. Moreover, the connection between the metal wire and the bulb will be easily loosened as the pipe-type lamp is bent for special use. So the current will be cut and the lamp will not work normally.

Accordingly, the present invention is to provide an improved pipe-type lamp, which is provided with inner printed circuit for connecting with the lighting bulb. Hence, the lamp can be used with utility and the circuit will never be cut. Now, accompanying with the following drawings, the character of the present invention will be described here and after.

### BRIEF DESCRIPTION OF THE DRAWINGS

FIG. 1 is a perspective view showing a conventional pipe-type lamp.

FIG. 2 is a cross-sectional plan view of FIG. 1.

FIG. 3 is a plan view of FIG. 2 showing the miniature bulb being replaced by the LED bulb.

FIG. 4 is a perspective view showing a pipe-type lamp with printed circuit according to the present invention.

FIG. 5 is a cross-sectional plan view of FIG. 4.

FIG. 6 is a perspective view showing the inner tube being provided with printed circuit according to the present invention.

FIG. 7 is a perspective view of FIG. 6 showing the inner tube being connected with the lighting bulbs.

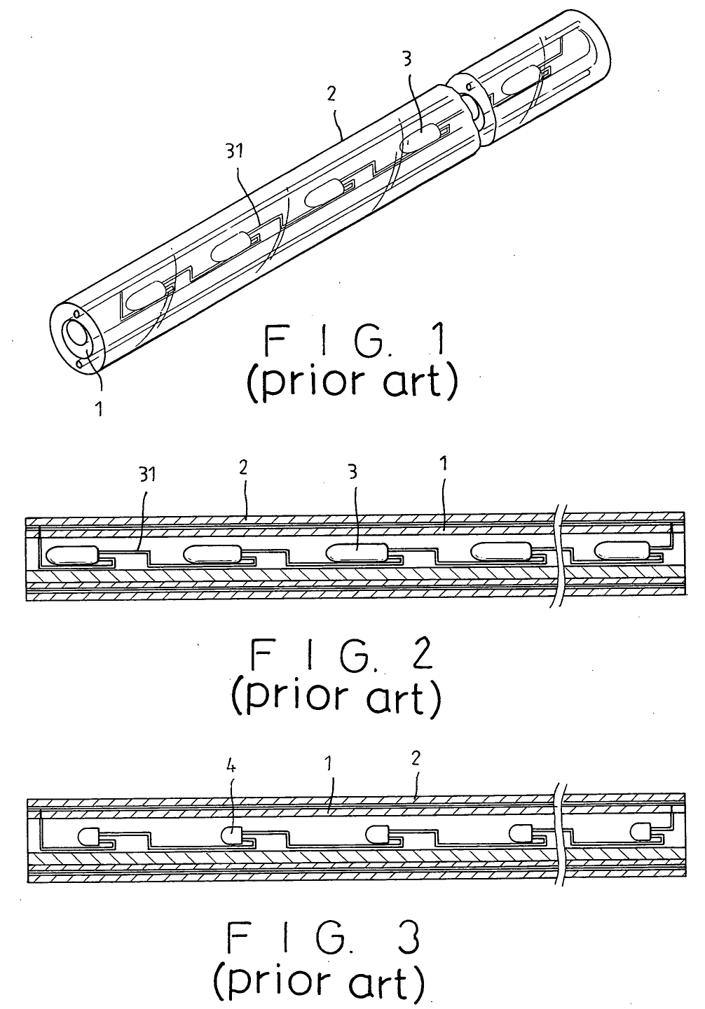

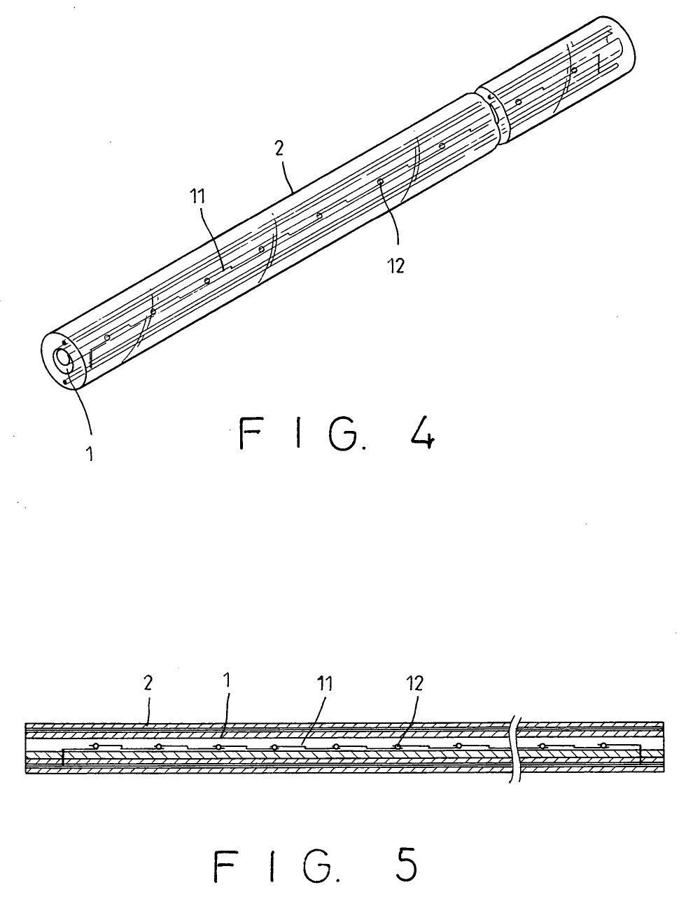

### DETAILED DESCRIPTION OF THE PREFERRED EMBODIMENT

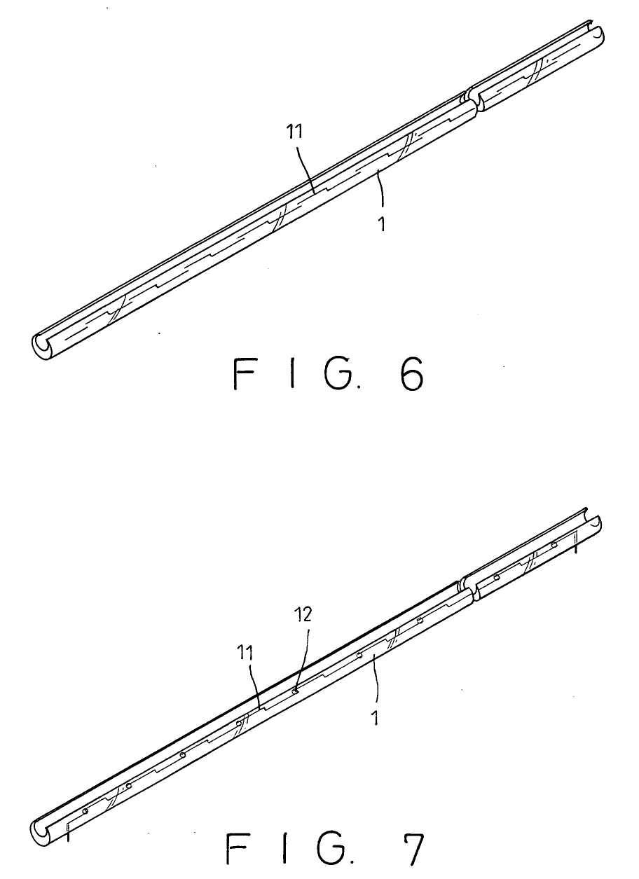

Please referring to FIG. 4 to 7, the present invention relates to a pipe-type lamp, which includes an inner tube (1) and an outer tube (2) as usual. The character of the present invention is to provide the inner tube (1) with printed circuit (11) directly. Then, the lighting bulbs (12) are mounted on the joint of the printed circuit (11) and a complete conductive electrical circuit is finished. Since the printed circuit (11) is printed on the inner tube (1), it is very easy and convenient. Meanwhile, the lighting bulb (12) is also capable of being mounted thereon that obtains a perfect electrical connection between the bulb and the circuit.

In use, the manufacture and assembly of the present invention will be more convenient and secure. A smaller pipe-type lamp can be also made because of the use of the printed circuit by this invention. Moreover, the pipe-type lamp according to the present invention can be bent as desired for wide use and the connection of the bulb and the circuit will be promised that overcomes the drawback of the conventional structures. In application, a controlling IC can also be printed to connect with the basic printed circuit to obtain a different twinkling effect and increase the decorative purpose.

It will be understood that the printed circuit can be designed as desired and can be printed on the inner surface or outer surface of the inner tube while the bulb is mounted on the joint of the circuit. It can obtain the predicted character of the present invention and will be claimed in this application.

1. A pipe-type lamp with printed circuit including an inner tube and an outer tube, wherein the inner tube is provided with printed circuit therein while the lighting bulbs are mounted of the joint of the circuit to complete a conductive circuit.

2. A pipe-type lamp with printed circuit as claimed in claim 1, wherein a controlling IC is printed and connected with the printed circuit on the inner tube to obtain a predicted twinkling effect.

3. A pipe-type lamp with printed circuit as claimed in claim 1, wherein the printed circuit can be printed on the inner or outer surface of the inner tube.
